(19) United States
(12) Patent Application Publication
(10) Pub. No.: US 2023/0168480 A1
(43) Pub. Date: Jun. 1, 2023

(54) HIGH-SPEED OPTICAL TARGETING SYSTEMS AND METHODS

(71) Applicant: President and Fellows of Harvard College, Cambridge, MA (US)

(72) Inventors: Adam Ezra Cohen, Cambridge, MA (US); Shane Nichols, Cambridge, MA (US); Vicente Jose Parot, Cambridge, MA (US); Hunter Davis Ozawa, Cambridge, MA (US)

(73) Assignee: President and Fellows of Harvard College, Cambridge, MA (US)

(21) Appl. No.: 17/920,352

(22) PCT Filed: Apr. 21, 2021
(86) PCT No.: PCT/US2021/028398

§ 371 Date: Oct. 20, 2022

Related U.S. Application Data
(60) Provisional application No. 63/013,240, filed on Apr. 21, 2020.

(51) Int. Cl. G02B 21/00; G02B 26/10

(52) U.S. Cl. CPC G02B 21/0048; G02B 26/105; G02B 2207/117

(57) ABSTRACT

High-speed optical targeting systems and methods are described, wherein a light source, e.g., a laser, is optically coupled with a spatial light modulator. Some embodiments include a device for two-dimensional light steering. In some embodiments, the device comprises a spatial light modulator, and a laser in optical communication with the spatial light modulator. In some exemplary methods, an area is scanned withing a microscope with millisecond revisit time, such as with at least 500 individually targeted points of light. In other exemplary methods, a beam of light is directed from a laser light source into an optical system, through which the light may be focused into a line on a spatial light modulator, wherein the light can be scanned across the spatial light modulator, and directed from the spatial light modulator onto a sample. Other exemplary methods are drawn to the construction and use of the embodiments escribed herein.

### RELATED APPLICATIONS

Foreign priority benefits are claimed under 35 U.S.C. § 119(a)-(d) or 35 U.S.C. § 365(b) of U.S. application No. 63/013,240, filed Apr. 21, 2020.

### GOVERNMENT FUNDING

This invention was made with government support under MH117042 awarded by National Institutes of Health. The government has certain rights in the invention.

### FIELD OF THE INVENTION

Aspects described herein generally relate to high-speed optical targeting systems and methods.

### BACKGROUND

Imaging of neural activity using fluorescence microscopy has revolutionized neuroscience research. Two-photon (2P) scanning microscopy is widely used to measure slow calcium transients, e.g., ˜1 second duration, of up to ˜10⁴ neurons deep in a living mouse brain. Recent advances in all-optical electrophysiology allow manipulation and recording of much faster electrical activity of neurons, such as having ˜1 millisecond action potential duration. However, current high-speed optical systems are limited to imaging less than 100 cells, due to spatiotemporal resolution limitations of conventional microscopes. In particular, two-photon (2P) excitation microscopes that densely cover an area cannot target optogenetic stimulation or recording to more than 100 neurons, with millisecond time resolution.

Many other optical devices would also benefit from faster beam targeting to multiple two-dimensional locations sequentially (‘scanning’). For example, the primary goal of laser ranging sensors in autonomous vehicle guidance systems is to map, in real time, the distance to surrounding objects, which is required to inform control decisions at short reaction times. This task can be challenging when the surroundings are sampled densely by conventional scanning systems, because high resolution sampling comes at the cost of reduced refresh rate. Targeted point-wise measurements could provide range information on hundreds of discrete objects individually with millisecond revisit intervals.

### SUMMARY

The present description generally relates to high-speed optical targeting systems and methods. The subject matter of the present description involves, in some cases, interrelated products, alternative solutions to a particular problem, and/or a plurality of different uses of one or more systems and/or articles.

One aspect is generally directed to a device, such as a device for two-dimensional light steering. In some embodiments, the device comprises a spatial light modulator, and a laser in optical communication with the spatial light modulator.

Another aspect is generally directed to a method comprising scanning an area in a microscope with millisecond time resolution, with at least 500 individually targeted points of light.

Yet another aspect is generally directed to a method comprising directing a beam of light from a laser light source into an optical system, focusing the beam of light into a line on a spatial light modulator, scanning the beam of light across the spatial light modulator, and directing the light from the spatial light modulator onto a sample.

A further aspect is generally directed to a method, comprising generating a low voltage differential signal (LVDS) clock signal from a laser oscillator signal of a laser, converting the low voltage differential signal (LVDS) clock signal to a timebase clock signal, down sampling the timebase clock signal to create a sample clock signal, down sampling the laser oscillator signal to produce a pulse picker clock signal, and adjusting the phase of the sample clock signal with the pulse picker signal, to produce a phase-shifted clock signal, and with the phase-shifted clock signal, synchronizing timing of pulses of light from the laser with galvo scanning of the light from the laser across the face of a spatial light modulator.

An additional aspect is generally directed to a method, comprising configuring a spatial light modulator to direct either even or odd rows to diffract a pulsed laser beam, measuring diffraction efficiency of the spatial light modulator and galvo feedback voltage for at the time of laser shot for a plurality of galvo cycles, constructing a map of diffraction efficiency as a function of galvo feedback voltage, and identifying the galvo feedback voltage that optimizes the diffraction efficiency for each row of the spatial light modulator.

Yet another aspect is generally directed to a method, comprising placing a pick-off mirror in an optical path of a laser scanning system to reflect a fraction of light from a laser onto a photodiode, the photodiode outputting a corresponding signal providing a reference of power for the laser, based on the photodiode signal, and normalizing recorded fluorescence of the light for the scanning system, based on the reference of power.

A further aspect is generally directed to a method comprising creating a wavelength-dependent regional lookup table to linearize phase response across the face of a spatial light modulator in a laser scanning system, and compensating for phase errors for a mapping of applied voltage to optical phase shift for the spatial light modulator in the laser scanning system, using the lookup table.

In another aspect, the present description encompasses methods of making one or more of the embodiments described herein. In still another aspect, the present description encompasses methods of using one or more of the embodiments described herein.

Other advantages and novel features of the present description will become apparent from the following detailed description of various non-limiting embodiments of the description, when considered in conjunction with the accompanying figures.

### BRIEF DESCRIPTION OF THE DRAWINGS

Non-limiting embodiments of the present description will be described by way of example with reference to the accompanying figures, which are schematic illustrations and are not intended to be drawn to scale. In the figures, each identical or nearly identical component illustrated is typically represented by a single reference numeral. For purposes of clarity, not every component is labeled in every figure, nor is every component of each embodiment of the description shown, where illustration is not necessary to allow those of ordinary skill in the art to understand the description. In the figures:

FIG. 1 is a schematic view of an exemplary device for high-speed scanning;

FIG. 2 is a flowchart of an exemplary method for high-speed scanning;

FIG. 3 is a flowchart of an alternate exemplary method for high-speed scanning;

FIG. 4 shows a full single scan of exemplary spatial light modulator (SLM) rows within a 1 ms time period;

FIG. 5 is a detailed view showing detection of every laser pulse at a frequency of 500 kHz;

FIG. 6 shows details showing detection while diffracting every other SLM row into a sample;

FIG. 7 is a fluorescent image of ˜500 photoconverted targets after sequential scanning through all target points in 1 ms;

FIG. 8 is a schematic view of an experimental preparation for exemplary 800 Hz two-photon fluorescence recording from a single targeted neuron in an acute mouse brain slice;

FIG. 9 is a static fluorescence image of a neuron expressing a fluorescent reporter in an acute brain slice;

FIG. 10 shows a relationship for glutamate as a function of time during electrical stimulation;

FIG. 11 illustrates an optical diagram of a hybrid scanning and holography device;

FIG. 12 is a schematic of an exemplary optical system in which the lower beam is the input beam;

FIG. 13 shows a diagram of scanned locations in an image plane;

FIG. 14 shows an optical diagram and simulation of a cylindrical scan lens, which propagates light from a hybrid scanner to an objective lens;

FIG. 15 is a schematic diagram of an exemplary structure and process for synchronizing laser pulses with galvo sweep;

FIG. 16 is a chart that shows pulsed signals that can be used to synchronize a galvo scan waveform with pulsed laser shots;

FIG. 17 is a chart showing diffraction efficiency as a function of galvo feedback voltage at time of laser shot;

FIG. 18 is a chart showing PMT voltage as a function of photodiode (PD) voltage; and

FIG. 19 shows, schematically, an illustrative computer on which some aspects of the technology described herein may be implemented.

### DETAILED DESCRIPTION OF INVENTION

Two-photon microscopy allows deep high-resolution imaging and photo-stimulation in scattering tissue such as a live brain, but existing beam-scanning systems are limited in their ability to target large populations of cells with millisecond time resolution.

Certain embodiments are directed to optoelectronic light targeting systems and methods that scan sequentially through ˜10³ point-wise targets at ˜1 microsecond between points and ˜1 millisecond between revisits. This allows excitation of ˜10³ neural targets for stimulation or recording at millisecond time resolution. Some embodiments of the optical targeting system may represent as much as a ˜10-fold improvement in speed over other point-scanning techniques, and may have applications in other domains, such as high-speed laser range-finding for automotive applications.

Some aspects are generally directed to two-dimensional microsecond light steering, towards the goal of improving the time resolution of targeted measurements and targeted photo-stimulation. In some cases, a scanner or other device selectively probes relevant points of interest over a large area in a sequential scan, thus achieving a high sampling frequency. This achieves microsecond time resolution scanning through sparsely targeted locations. When paired with a femtosecond pulsed laser source operating at a high pulse repetition rate, e.g., 500 kHz, the scanner may provide independent two-photon excitation of multiple locations, e.g., 512 locations, at high revisit rates, e.g., 800 Hz. In some embodiments, the scanner may be used for sequentially visiting targets at intervals of 2 microseconds. This may allow in some embodiments for the possibility of large-scale optically targeted electrical recording and optogenetic stimulation at high time resolutions, e.g., millisecond timescales.

Other pulsing frequencies that may be used in some embodiments include at least 10 kHz, at least 20 kHz, at least 30 kHz, at least 50 kHz, at least 100 kHz, at least 200 kHz, at least 300 kHz, at least 500 kHz, at least 1 MHz, at least 2 MHz, at least 3 MHz, at least 5 MHz, etc. Other time resolutions include at least 10 kHz, at least 20 kHz, at least 30 kHz, at least 50 kHz, at least 100 kHz, at least 200 kHz, at least 300 kHz, at least 500 kHz, at least 1 MHz, at least 2 MHz, at least 3 MHz, at least 5 MHz, etc. The number of locations may also vary, e.g., at least 50 locations, at least 100 locations, at least 200 locations, at least 300 locations, at least 400 locations, at least 500 locations, at least 750 locations, at least 1000 locations, at least 2000 locations, at least 3000 locations, at least 5000 locations, etc.

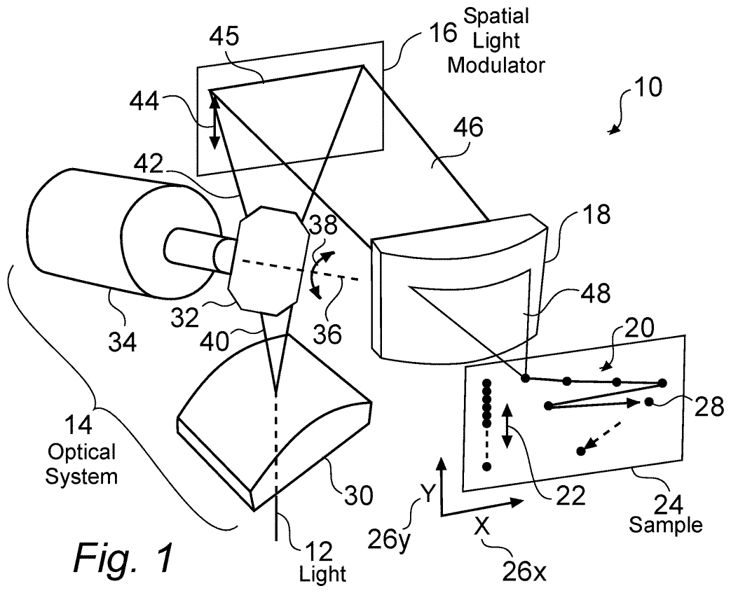

Some aspects may generally be directed to a high-speed targeting system. As well, some exemplary embodiments may be directed to a hybrid light steering system that combines fast periodic scanning along one dimension with a spatial light modulator (SLM) based optical targeting along the orthogonal dimension. As a non-limiting example, FIG. 1, this is depicted as fast periodic scanning 22 along y-axis 26y, with SLM 16 based optical targeting along x-axis 26x, which is orthogonal to y-axis 26y.

In some embodiments, a SLM (such as SLMs 16 in FIG. 1) may include liquid crystal on silicon (LCOS) chips or digital micromirror devices (DMDs), and can have a high number of degrees of freedom to manipulate light. Thus, the illumination pattern is an arbitrary function {x}(y), where {x} denotes a set of one or more x coordinates that are targeted for each y coordinate. In some embodiments, the system can be operated with continuous or pulsed light, e.g., continuous wave (CW) light, or with a pulsed laser, etc. In the latter case, a galvanometric (galvo) scan waveform can be adjusted in some embodiments to ensure that a predetermined or constant number of laser pulses lands on each SLM row. In some embodiments, a single laser pulse may land on some, or each, SLM row, although in other embodiments, two, three, or more pulses may land on each row.

In some exemplary embodiments, a focused spot of light is scanned in a 2P fluorescence microscope. A large area can be addressed, such as with millisecond time resolution. Other time resolutions include at least 10 kHz, at least 20 kHz, at least 30 kHz, at least 50 kHz, at least 100 kHz, at least 200 kHz, at least 300 kHz, at least 500 kHz, at least 1 MHz, at least 2 MHz, at least 3 MHz, at least 5 MHz, etc. As well, individually targeted points of light can be delivered to a relatively large number of locations, such as at least 50 locations, at least 100 locations, at least 200 locations, at least 300 locations, at least 400 locations, at least 500 locations, at least 750 locations, at least 1000 locations, at least 2000 locations, at least 3000 locations, at least 5000 locations, etc.

FIG. 1 is a schematic view of an exemplary device 10 for high-speed selective access 2P scanning 22, such as comprising an optical system 14 for selectively directing 40, 42 a beam of light 12 from a laser to be focused onto a spatial light modulator (SLM) 16, where the light 12 can be further optically processed 18 for scanning 22, such as onto a sample 24. The exemplary optical system 14 seen in FIG. 1 includes a galvanometric mirror 32, i.e., a galvo 32, which may be controllably moved 38, such as about an axis 36, by a galvo motor 34, whereby light 12, such as directed 40 through a lens 30, is directed 42 toward the SLM 16.

A combination of periodic scanning and static holography can be used to achieve fast 2D selective targeting. In some embodiments, a standard circular lens may be included. For example, this is shown in the example of FIG. 1 as a lens between the galvo 32 and the SLM 16. As further seen in FIG. 1, incident light 42 on the SLM can be directed 46, such as though a lens 18, so that the light 18 may be focused.

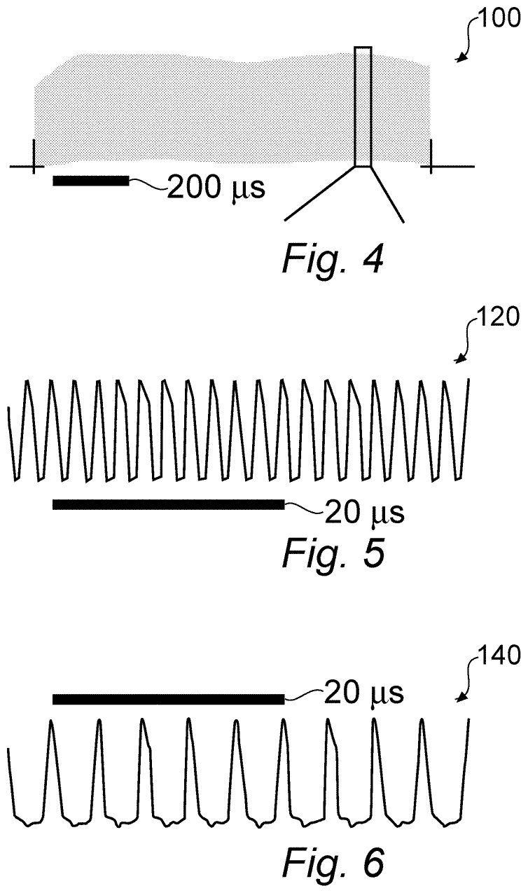

FIGS. 4, 5, and 6 show different views of an exemplary two-photon fluorescence waveform recorded from a fluorescein sample for timing calibration. For instance, FIG. 4 is a full single scan 100 of 512 SLM rows in 1 ms. The number of SLM rows that may be scanned by the two-photon fluorescence waveform may vary, such as at least 50 rows, at least 100 rows, at least 200 rows, at least 300 rows, at least 400 rows, at least 500 rows, at least 750 rows, at least 1000 rows, at least 2000 rows, at least 3000 rows, at least 5000 rows, etc.

FIG. 5 is an exemplary zoom-in view 120 of the detection of every laser pulse at 500 kHz via two-photon fluorescence. Detection of every pulse via two-photon fluorescence may also be provided at other frequencies, e.g., at least 10 kHz, at least 20 kHz, at least 30 kHz, at least 50 kHz, at least 100 kHz, at least 200 kHz, at least 300 kHz, at least 500 kHz, at least 1 MHz, at least 2 MHz, at least 3 MHz, at least 5 MHz, at least 80 MHz, etc.

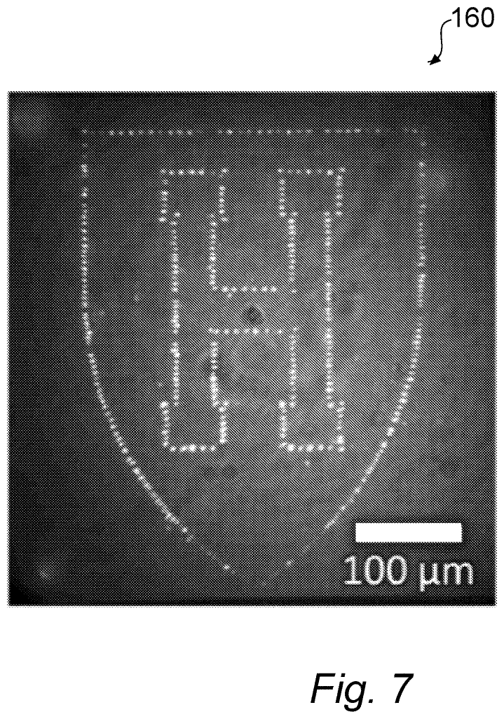

FIG. 6 shows a similar scan 140, while only diffracting every other SLM row onto a sample 24 (FIG. 1). FIG. 7 is a fluorescent image 160 of ˜500 photoconverted targets after sequential scanning 22 through all target points in 1 ms, such as along a path 20 (FIG. 1).

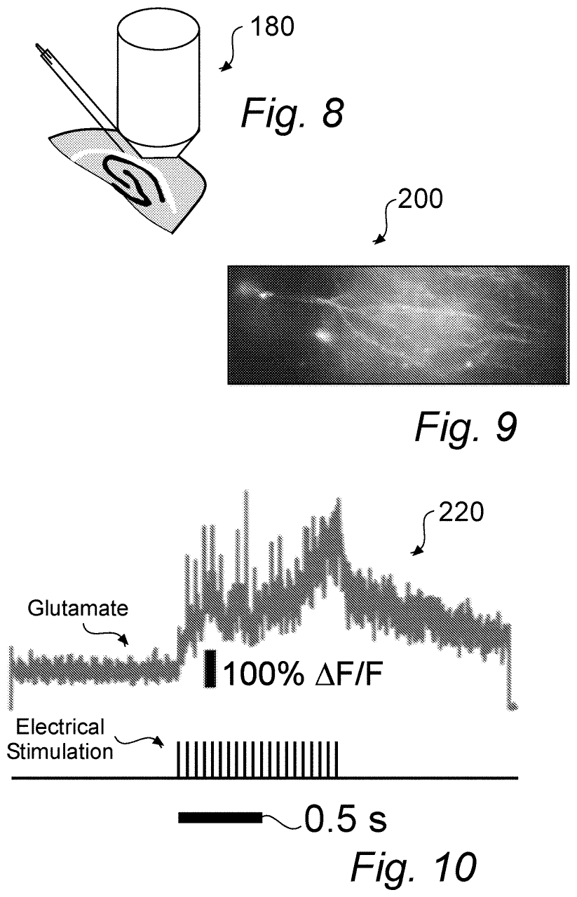

FIGS. 8, 9, and 10 show exemplary 800 Hz two-photon fluorescence recording from a single targeted neuron in an acute mouse brain slice, expressing the glutamate reporter yGluSnFr. A neonatal mouse pup was injected with an adeno-associated virus (AAV) encoding a cre-dependent yGluSnFr gene. A second AAV, encoding the Cre virus under control of the human synapsin promoter activated expression of yGluSnFr in a sparse subset of hippocampal neurons. 16 days after the viral injections, the mouse was sacrificed and acute brain slices were prepared. A fluorescence recording was targeted to a neuron in the CA1 region of the hippocampus, while electrical activity was evoked by electric field stimulation in region CA3. For example, FIG. 8 is a schematic depiction 180 of the experimental preparation, while FIG. 9 is a static fluorescence image 200 of a neuron expressing the fluorescent reporter in an acute brain slice. FIG. 10 is an exemplary view 220 that shows fast rises in the extracellular glutamate concentration which are detected upon synaptic release elicited by individual electrical pulses, in which accumulation of glutamate upon repeated stimulation indicates synaptic facilitation.

In an exemplary embodiment as shown, the number of targets was set by the SLM rows (such as 512 in this example), and the interval between targets was set by the laser repetition rate configuration (such as 500 kHz in this example). The exemplary 400 Hz scan period shown in this example was fixed by twice the product of the number of rows and the interpulse interval, plus galvo turnaround time. In other embodiments, however, these parameters may achieve greater than 1000 targets, such as by using an SLM 16 with more rows, and faster addressing and scan rate, using a higher laser repetition rate. For instance, in some embodiments, an SLM having a different number of rows may be used, such as at least 50 rows, at least 100 rows, at least 200 rows, at least 300 rows, at least 400 rows, at least 500 rows, at least 750 rows, at least 1000 rows, at least 2000 rows, at least 3000 rows, at least 5000 rows, etc. In some embodiments, different addressing and scan rates may be used, such as at least 100 Hz, at least 500 Hz, at least 1 kHz, at least 5 kHz, at least 10 kHz, at least 20 kHz, etc. In some embodiments, different laser repetition rates may be used, such as at least 10 kHz, at least 20 kHz, at least 30 kHz, at least 50 kHz, at least 100 kHz, at least 200 kHz, at least 300 kHz, at least 500 kHz, at least 1 MHz, at least 2 MHz, at least 3 MHz, at least 5 MHz, at least 80 MHz, etc.

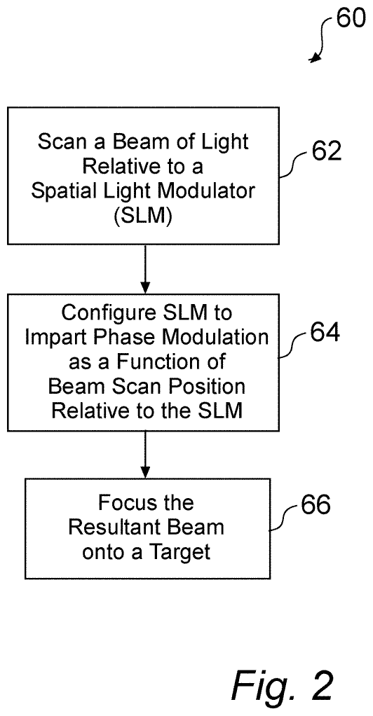

FIG. 2 is a flowchart of an exemplary method 60 for high-speed scanning. The exemplary method 60 seen in FIG. 2 proceeds by scanning 62 a beam of light 12 (FIG. 1) relative to a spatial light modulator (SLM) 16 (FIG. 1). As also seen in FIG. 2, the SLM 16 is configured 64 to impart phase modulation as a function of beam scan position relative to the SLM 16. As further seen in FIG. 2, the resultant beam 46 is focused 66 onto a target 24 (FIG. 1).

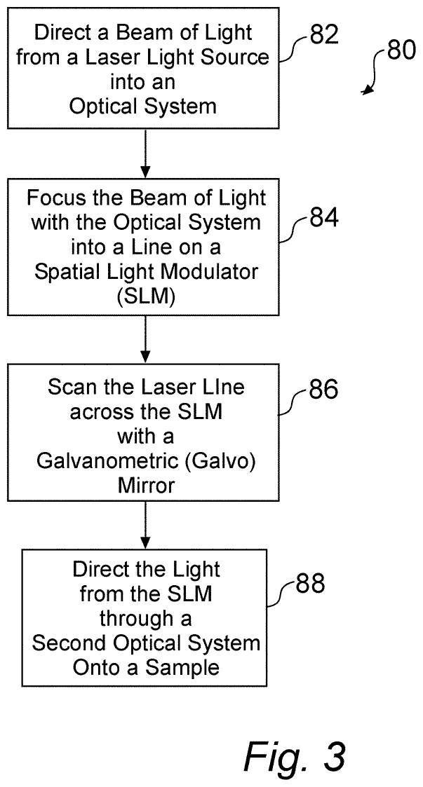

FIG. 3 is a flowchart of an alternate exemplary method 80 for high-speed scanning. The exemplary method 80 seen in FIG. 3 proceeds by directing 82 a beam of light 12 from a laser light source through an optical system 14. As further seen in FIG. 3, the optical system may be arranged to focus the beam of light into a line, e.g., 45, on a spatial light modulator (SLM) 16. In some embodiments, the SLM 16 is a liquid crystal SLM 16. In some embodiments, the beam of light 12 is focused 84 such that the width of the line 45 corresponds approximately to one pixel-width on the SLM 16. As also seen in FIG. 3, a galvanometric mirror 32, i.e., a galvo 32 (FIG. 1), may be arranged or otherwise controlled 38 to scan 86 the focused laser line 45 across the SLM 16.

As further seen in FIG. 3, an optical system 18 may be arranged to direct the light from the SLM onto a sample. For instance, the light may be directed such that positions along the scan direction Y at the SLM 16 map linearly to y-positions on the sample 24, and angular deflections along the orthogonal direction X at the SLM 16 map to x-positions on the sample 24.

For embodiments in which the light source is pulsed, e.g., such as with a femtosecond laser, the method may further comprise synchronizing the galvo positions with the laser pulses, i.e., shots, so that a fixed integer number of laser shots land on each SLM column.

In some embodiments, the SLM may be arranged into a rectangular grid of sub-regions. In some embodiments, the laser beam is shaped into a spot, to fill a single sub-region. In other embodiments, the laser beam may be scanned, via galvo mirrors (e.g., 32 in FIG. 1), to sequentially visit each sub-region of the SLM.

In some embodiments, the device may use an infrared femtosecond pulsed laser. The device may scan the beam in one dimension using a galvanometric mirror, and holographically refocus the light along a second dimension, for example, using a LCOS SLM, or a digital micromirror device (DMD). The beam can then be directed through various optics, e.g., a microscope objective (such as 18 in FIG. 1), to achieve multiphoton excitation of a predefined set of target points in a plane.

In some embodiments, any light source may be used. In some embodiments, the light source is a laser, such as a fiber laser. For example, the laser may be an Amplitude Systems Satsuma fiber laser, that is capable of providing up to 10 W of light at a repetition rate of 500 kHz, a wavelength of 1030 nm, and a pulse duration of less than 350 fs. Other light sources are also available commercially.

Similarly, in some embodiments, any spatial light modulator (SLM) may be used. One non-limiting example is a Meadowlark ODP 512 spatial light modulator, which has a 512×512 pixel chip, a pitch of 15 micrometers, a diffraction efficiency greater than 95 percent, and a fill factor greater than 83 percent. Other types of spatial light modulators can be readily obtained commercially. In some embodiments, the first lenses in the optical path, e.g., first lenses 30 (FIG. 1), can expand the laser beam. As a non-limiting example, the beam can be expanded to ˜8 mm diameter, such as to fill a 7.7 mm×7.7 mm SLM chip 16 as is shown in FIG. 1.

In some embodiments, a beam expander, such as a Galilean beam expander, may be used, such as to avoid focusing the high energy pulses to a small spot in space, such as to avoid arcing or thermal currents, which may otherwise distort and steer the beam. Other beam expanders can also be obtained commercially. In some embodiments, the expanded beam may be directed through a paired cylindrical, i.e., tube, lens and scan-lens, having matched focal lengths.

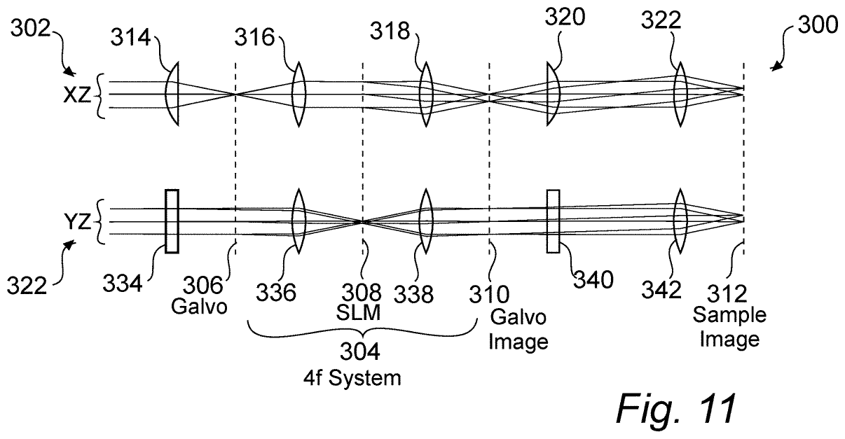

FIG. 11 illustrates an optical diagram of a hybrid scanning and holography device 300, such as including a first optical channel 302 and a second optical channel 322, which each extend to a sample image 312, sequentially through a galvo 306, an SLM 308, and a galvo image 310, before arriving at the sample image 312. As seen in FIG. 11, the first optical cannel 302, corresponding to XZ, also includes a sequential arrangement of optical elements 314, 316, 318, 320, and 322, with respect the galvo 306, the SLM 308, and the galvo image 310.

Similarly, as also seen in FIG. 11, the second optical channel 322, corresponding to YZ, also includes a sequential arrangement of optical elements 334, 336, 338, 340, and 342, with respect the galvo 306, the SLM 308, and the galvo image 310.

In FIG. 11, Z is the propagation direction, from left to right. Transversal dimensions X and Y are focused independently by the cylindrical lens L1. Because the beam is reflected by the SLM 308, L2 in the middle and right corresponds to the same physical element. For the first optical channel 302, in the Y dimension, L1 focuses the light 12 up to the diffraction limit. For the second optical channel 322, in the X dimension, L1 propagates the light 12, without focusing.

### Clock Generation and Synchronization.

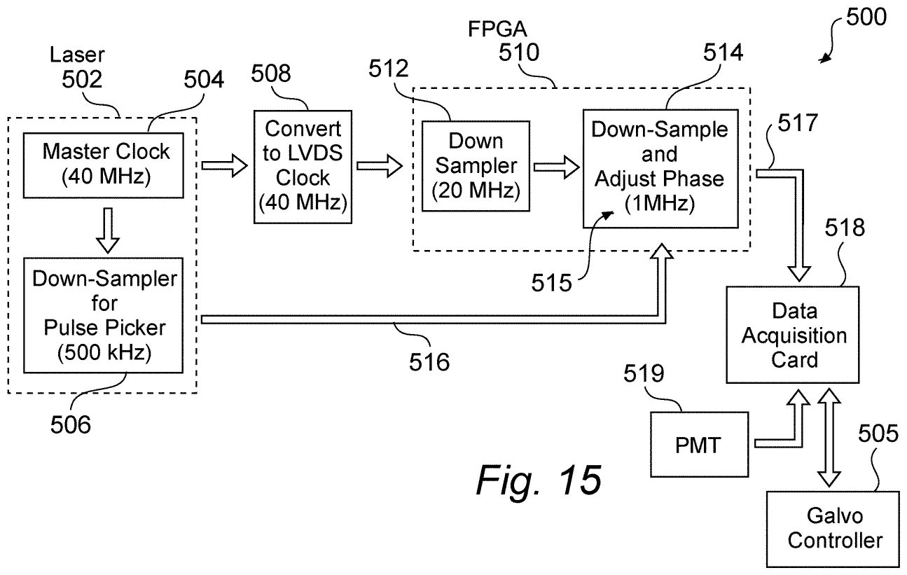

For some embodiments in which the optical targeting system is used with a pulsed laser 502 (FIG. 15), the timing of the laser pulses is precisely synchronized with the galvo scanning of the laser beam 12 across the face of the SLM 16. To target one laser pulse to each of 512 SLM rows, the scan pattern may be synchronized to be accurate to much less than 1 part in 512, or approximately 0.2%. For a typical arrangement where the laser sweeps across the face of the SLM 16 in 1 ms, the timing of the SLM waveform may be synchronized be accurate to much less than 2 microseconds.

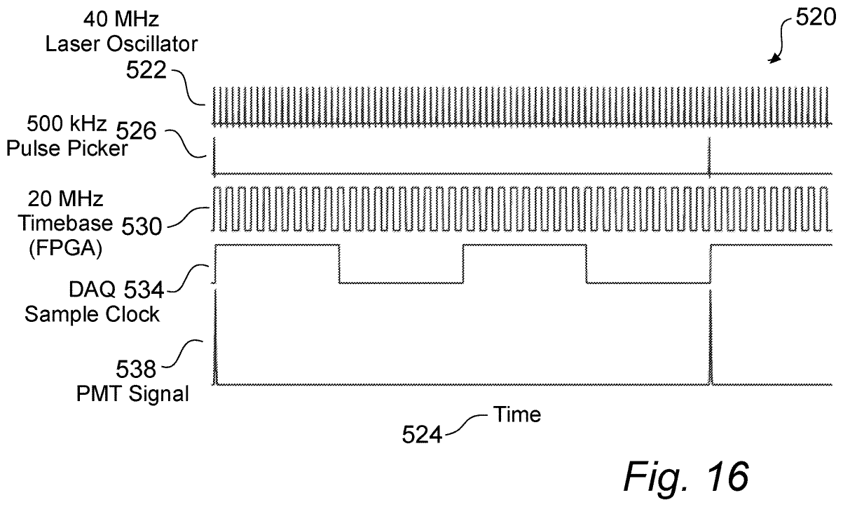

FIG. 15 is a schematic diagram of an exemplary structure and process for synchronizing laser pulses with galvo sweep. FIG. 16 is a chart 520 that shows pulsed signals associated with the exemplary structure and process as seen in FIG. 15, which can be used to achieve precise synchronization of the galvo scan waveform with pulsed laser shots.

In the exemplary embodiment see in FIG. 15, the master clock 504 for the system is driven by the 40 MHz laser oscillator signal 522 (FIG. 16). As further seen in FIG. 15, the 40 MHz laser oscillator signal 522 is routed through a high speed comparator to generate a low voltage differential signal (LVDS) clock 508. The exemplary 40 MHz LVDS clock 508 seen in FIG. 15 is then routed to a field programmable gate array (FPGA) 510, which in one embodiment is an Intel Cyclone® V FPGA, available through Intel Technologies, of Santa Clara, Calif. For the exemplary structure and process 500 shown schematically in FIG. 15, the FPGA 510 is programmed to convert 512 the LVDS signal 508 from the laser 502 into a timebase 20 MHz clock signal 530 with a 50% duty cycle, such as seen in FIG. 16. The 20 MHz clock signal 530 is then down-sampled 514, such as with a phase-locked loop (PLL), to create a “sample clock” 534 at 1 MHz.

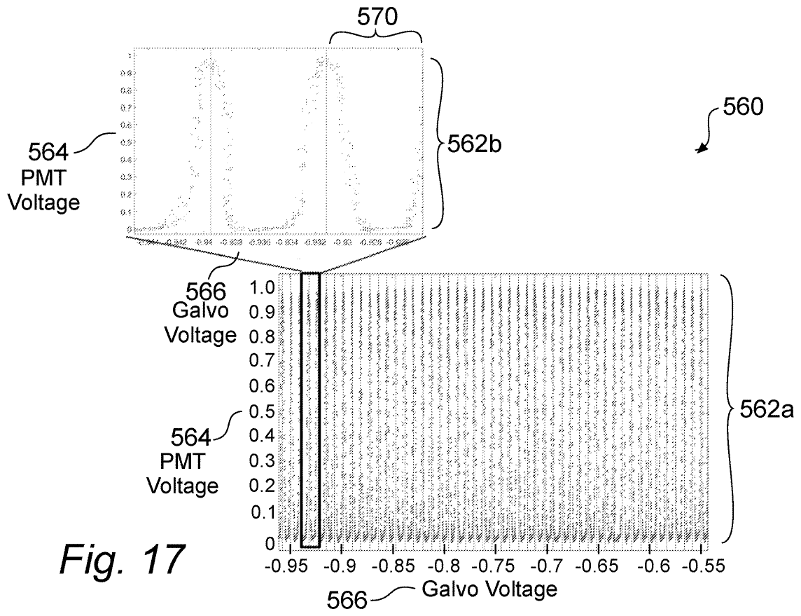

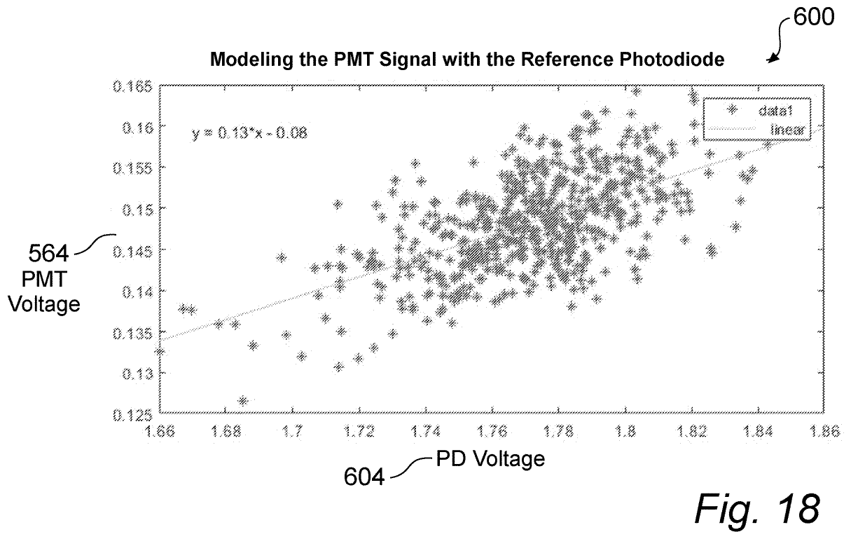

In the exemplary embodiment seen in FIG. 15, the laser 502 also internally down-samples 506 its 40 MHz clock 522 to generate a 500 kHz clock 526 (FIG. 16), which drives the pulse-picker that sets the output of the laser 502. The PLL in the FPGA 510 allows for adjustments 515 of the sample clock phase relative to 516 the pulse picker clock 526. Phase adjustment 515 is necessary to ensure that data acquisitions 518 from the photomultiplier tube (PMT) 519 are triggered at the maximum of the PMT signal 564 (FIG. 17, FIG. 18). As further seen in FIG. 15, the 1 MHz sample clock signal 534 is then output 517 to the data acquisition card 518, such as via a coaxial cable. The data acquisition card 518 may also exchange information with the galvo controller 505, so that the galvo motion can be synchronized to the laser clock.

### Galvo Waveform Calibration.

FIG. 17 is a chart 560 illustrating diffraction efficiency as a function of galvo feedback voltage 566 at time of laser shot. In some embodiments, the galvo waveform is synchronized with the laser pulses, to ensure that each laser pulse is properly targeted onto a single row of the SLM 16. In some such embodiments, an automated routine may be implemented perform this calibration, such as through the use of a computer system. For example, the system can configure the SLM 16 to direct either even or odd rows to the sample. In some embodiments, the galvo 32 is driven at approximately the target frequency and with the target waveform, but with a clock source that is asynchronous to the sample clock 534.

The system then measures the SLM diffraction efficiency and galvo feedback voltage 566 at the time of each laser shot. By accumulating these measurements over many galvo cycles 570, a map 560 can be constructed of diffraction efficiency as a function of galvo feedback voltage. For example, the chart 560 seen in FIG. 17 shows two portions 562a, 562b that plot PMT voltage 564 as a function of galvo feedback voltage 566 over a sequence of galvo cycles 570, in which the second portion 562b provides a more detailed view of a portion of the information shown in the first portion 526a. Using this information, the system can identify the galvo feedback voltage 566 that optimizes the diffraction efficiency for each row of the SLM 16.

In some embodiments, the exemplary system may then switch to timing the galvo waveforms off the sample-clock 534 from the FPGA 510 (FIG. 15), such as by defining a waveform that seeks to align successive laser shots with the optimal galvo feedback voltages 566 for successive rows. The exemplary system may also compensate for errors caused by delays in the photodetector and galvo feedback voltage, such as by adjusting the phase of the galvo-control waveform, e.g., via circular permutation, until the optimal diffraction is achieved. The calibration of the galvo waveform can thus be used to ensure efficient and consistent diffraction off the SLM 16.

### Correction for Variations in Laser Pulse Energy.

FIG. 18 is a chart 600 showing PMT voltage 564 as a function of photodiode (PD) voltage 604. Variations in laser intensity can lead to correlated PD voltage and fluorescence signals detected on the photomultiplier tube (PMT). The PD signals can be used to correct for shot-to-shot variations in laser power.

To meet the stringent signal-to-noise ratio (SNR) requirements of two-photon fluorescence recording, some system embodiments compensate for the pulse-to-pulse noise from high-power fiber lasers. For example, in some embodiments, a pickoff mirror, such as placed just before the tube lens, can reflect a small fraction, e.g., 4%, of the light onto a photodiode. This photodiode signal can provide a reference for laser power, which can be used to normalize the recorded fluorescence, such as to improve the SNR of the fluorescence recordings.

### Compensation for Spatial Inhomogeneity of Phase Response and Focus Across the SLM.

SLMs 16 often have slight variations across their face in the mapping of applied voltage to optical phase shift. In some embodiments, a wavelength-dependent regional lookup table is used in software to linearize the phase response, to compensate for these phase errors. In some embodiments, the use of such a lookup table allows efficient diffraction and focusing of laser light 12 with wavelengths from 750 nm to 1300 nm.

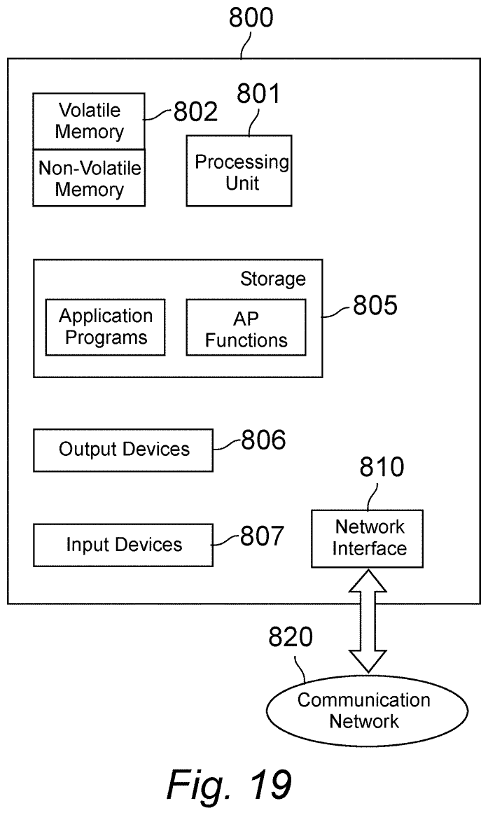

FIG. 19 shows, schematically, an illustrative computer 800 on which aspects of the present disclosure may be implemented. In the embodiment shown in FIG. 19, the computer 800 includes a processing unit 801 having one or more processors and a non-transitory computer-readable storage medium 802 that may include, for example, volatile and/or non-volatile memory. The memory 802 may store one or more instructions to program the processing unit 801 to perform any of the functions described herein. The computer 800 may also include other types of non-transitory computer-readable medium, such as storage 805 (e.g., one or more disk drives) in addition to the system memory 802. The storage 805 may also store one or more application programs and/or resources used by application programs (e.g., software libraries), which may be loaded into the memory 802.

The computer 800 may have one or more input devices and/or output devices, such as devices 806 and 807 illustrated in FIG. 19. These devices can be used, among other things, to present a user interface to one or more users. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 807 may include a microphone for capturing audio signals, and the output devices 806 may include a display screen for visually rendering, and/or a speaker for audibly rendering, recognized text. As another example, the input devices 807 may include sensors or detectors.

As shown in FIG. 19, the computer 800 may also comprise one or more network interfaces (e.g., the network interface 810) to enable communication via various networks (e.g., the network 820). Examples of networks include a local area network or a wide area network, such as an enterprise network or the Internet. Such networks may be based on any suitable technology and may operate according to any suitable protocol and may include wireless networks, wired networks or fiber optic networks. Such networks may include analog and/or digital networks.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Also, the various methods or processes outlined herein may be coded as software that is executable on one or more processors that employ any one of a variety of operating systems or platforms. However, it should be appreciated that aspects of the present disclosure are not limited to using an operating system. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure described above. The computer-readable medium or media may be transportable, such that the program or programs stored thereon can be loaded onto one or more different computers or other processors to implement various aspects of the present disclosure as described above.

The terms “program” or “software” are used herein to refer to any type of computer code or set of computer-executable instructions that can be employed to program a computer or other processor to implement various aspects of the present disclosure as described above.

Additionally, it should be appreciated that according to some aspects, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

### EXAMPLES

The following examples are intended to illustrate exemplary embodiments of the present description, but do not exemplify the full scope of the description.

In one example, for an SLM fill factor of 0.83, an exemplary device may have an active pixel width of 15\sqrt{0.83}=13.7 (micrometers). For an exemplary diffraction limited scan lens and Gaussian profile beam, the spot width on the SLM can be shown as:

$${d}_{2} = \frac{4 f λ}{π {d}_{1}} .$$

This suggests an ideal focal length of 75 mm for this device. Experimental test of a focal length of 50 mm was successful. The scan lens uses the Plossl design, which is a type of telecentric, symmetric scan lens comprised of two face-to-face achromatic doublets with a focal length given by:

$$\frac{1}{f} = \frac{1}{{f}_{1.}} + \frac{1}{{f}_{2.}}$$

This configuration was experimentally found to work well using close values for the two focal lengths f₁ and f₂. One implementation uses two AC508-100-B lenses, having a focal length of 100 mm. In such a configuration, a small amount of space, e.g., 1 mm, between the lenses avoids interference effects from back-reflections.

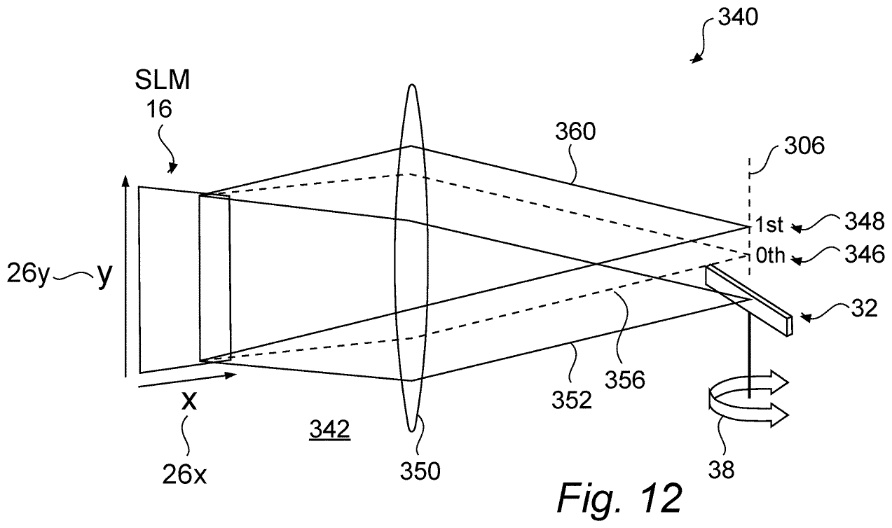

In this exemplary device, the SLM 16 is positioned with its center aligned with the axis of the scan lens. To allow retroreflection off the SLM 16, the galvo 32 is offset two millimeters from the SLM and lens optical axis, while the reflected zero order beam is displaced by the same amount on the opposite side of the optical axis. For the exemplary configuration shown, only the positive first diffraction order is used. The first-order diffraction 348 occupies a region of space shifted slightly further than the zero-order beam 346, as depicted in FIG. 12.

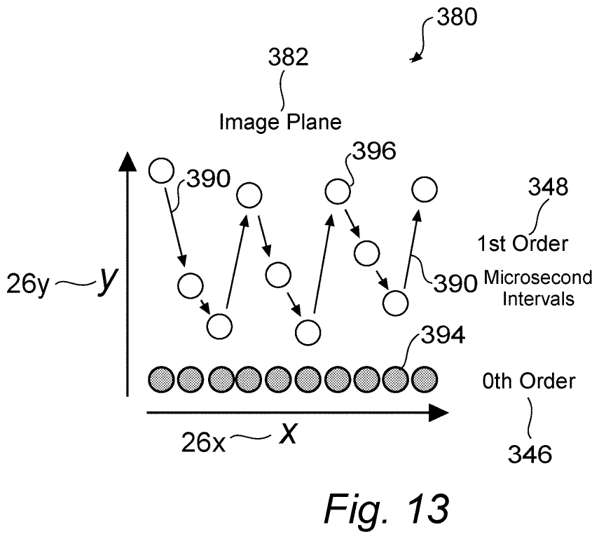

FIGS. 12, 13, and 14 provide schematic views in accordance with an exemplary non-limiting embodiment 352, which includes a lens system 350 located between a galvo 32 located at a galvo plane 306 and the SLM 16. In FIG. 12, the lower beam 352 is the input beam, corresponding to the galvo 32. The upper beam 360 is the first-order diffracted component 348, and the dotted outline 356 is the zero order diffracted component 346. FIG. 13 shows a diagram 380 of the scanned locations 394, 396 in the galvo image plane 306, such as corresponding to microsecond intervals 398.

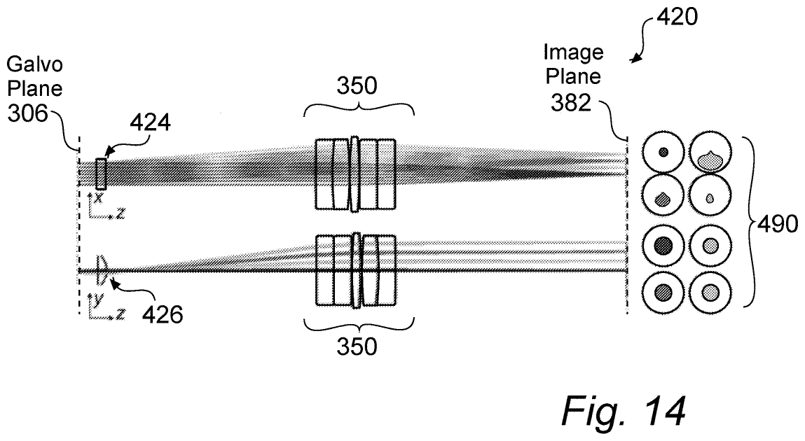

FIG. 14 shows an optical diagram 420 and a simulation 490 of the cylindrical scan lens 350, which propagates light 12 from the hybrid scanner to an objective lens. This region, near the galvo 32, is an image plane 386 in the diffraction direction (yz), and a Fourier plane in the scanning direction (xz). The design of the last imaging component optimized the optical invariant of the SLM output. For some exemplary embodiments, the design of a large field-of-view two-photon microscope can be accomplished through optical invariant analysis. At any plane (image or pupil), the product of the plane radius and the sine of the field angle is an invariant. Typically, the small angle limit applies and the sine can be omitted, except at the image plane in front of an objective. Whichever optic has the smallest invariant limits the bandwidth for the entire system. The design in this example ensures that this limiting optical component is the microscope objective. Ideally, the illumination will maximize the bandwidth, so that both the conjugate image plane and the objective rear pupil plane are filled, as this gives the smallest possible spot size over the whole field of view. With high power pulsed lasers, overfilling of the objective should be avoided or minimized, as this can result in light 12 hitting the interior walls of the objective, which can damage the objective.

In the xy plane, the Plossl scan lens is a true f-theta lens, meaning that the displacement of the spot on the SLM, x, is given by x=fθ. The full angular range is thus (7.7 mm/50 mm)=8.8 degrees. Note that this translates to a range of 2.2 V applied to the galvo scanner (there is a factor of four from volts to optical angle, or a factor of two from volts to mechanical angle due to the law of reflections). The beam radius on the galvo is 4 mm, such that:

I=4.0 sin(4.4 deg)=0.307 mm.

In the yz direction, the radius of the image plane, near the galvo, is determined by the diffraction angular range of the SLM chip. The grating period is 15 um, and the minimum recommended pitch is 4 pixels. Bragg's Law at normal incidence is given as:

d sin θ=λ,

such that θ=1.31deg, which corresponds to a 1.14 mm image plane. The full angle is 8.8 deg, giving an invariant of 0.044.

Because both invariants are smaller than the objective's (0.378), both image planes are safely reimaged to the field number of the objective. The field number is the size of the conjugate image plane in front of the tube lens, assuming the manufacturer specified tube lens focal length is used. Olympus uses 180 mm focal length tube lenses; however the design in this example uses a Thorlabs 200 mm focal length tube lens, so the target field number can be adjusted by 200/180. The Olympus XLPLN25XWMP2 has a field number of 18 mm, which can be adjusted to 20 mm.

In the xy direction, the galvo plane is a Fourier plane that is to be imaged to 20 mm. To figure out the required focal length, consider that the scan lens acts as the first half of a relay, thus the scan lens and the lens to be added reimage a 8 mm plane to 20 mm and have a magnification of 20/8=2.5. The required focal length of the lens to be added is therefore 2.5*50 mm=125 mm. The ideal distance of the new image plane from the galvo plane is 2f or 250 mm. In the yz direction, the galvo plane is an image plane that needs to be reimaged. The tube lens-objective relay needs to accept a field that is approximately telecentric, so the lenses is incorporated to reimage the galvo plane in the yz direction should be telecentric. One way to do this is to use a 4f relay. The magnification should be f₂/f₁=20/1.14=17.5, and that 2f₁+2f₂₌₂₅₀ mm. Solving these two equations gives f₁=6.75 mm and f₂=118 mm.

Cylindrical lenses with these focal lengths are not available as off-the-shelf components. Optimization in Zemax using commercially available lenses did not produce a perfect design. Also, the very short focal length of f1 represented a concern due to practical housing limitations of commercially available lenses. The galvo 32 is 12 mm long, which, projected onto the optic axis puts the edge of the galvo 32 about 4.5 mm from the center of f₁. In other words, for this exemplary configuration, the galvo 32 and the lens would be almost touching.

Because commercially available lenses did not allow a perfect 17.5×relay, the conjugate image plane size was progressively shrunk, based on available high power lenses for f₁. A cylindrical aspheric lens with a focal length of 8 mm was chosen, leaving a space between the galvo and the f₁. The remaining three lenses shown in FIG. 14, were 1) 200 mm cylindrical achromatic doublet, 2) 150 mm biconvex spherical, and 3) 150 mm cylindrical achromatic doublet. Lenses 1 and 2 form an effective 85 mm lens in the xz plane while lenses 2 and 3 form an effective 75 mm lens in the yz plane. The first pair, with a 10 mm longer focal length is conveniently located with its center about 10 mm behind the second pair, thus aligning the image planes approximately, leveraging the long Rayleigh length in the yz direction.

To confirm that the objective is overfilling in the xz plane, the tube lens and the 85 mm lens together reimage the galvo onto the objective back aperture to a size of 200/85*8=18.8 mm. The XLPLN25XWMP2 has a rear pupil of 15.5 mm, which is slightly overfilled, but other objectives have larger pupil sizes, such as the Olympus 10×multiphoton objective which has a rear pupil of 22 mm.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the present disclosure. Further, though advantages of the concepts described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

While several embodiments of the present description have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present description. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present description is/are used. Those skilled in the art will recognize, or be able to ascertain using no more than routine experimentation, many equivalents to the specific embodiments, as described herein. It is, therefore, to be understood that the foregoing embodiments are presented by way of example only and that, within the scope of the appended claims and equivalents thereto, the description may be practiced otherwise than as specifically described and claimed. The present description is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present description.

Various aspects of the concepts disclosed herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, many of the concepts disclosed herein may be embodied as a method, of which one or more examples has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

In cases where the present description and a document incorporated by reference include conflicting and/or inconsistent disclosure, the present description shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives, i.e., “one or the other but not both”, when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the description includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within .+−0.20% of a target value in some embodiments, within .+−.0.10% of a target value in some embodiments, within .+−0.5% of a target value in some embodiments, within.+−0.2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of patent Examining Procedures, Section 2111.03.

What is claimed is:

1. A device for two-dimensional light steering, comprising:
a spatial light modulator; and
a laser in optical communication with the spatial light modulator.

2. The device of claim 1, wherein the spatial light modulator comprises a liquid crystal on silicon chip.

3. The device of any preceding claim, wherein the spatial light modulator comprises a digital micromirror device.

4. The device of any preceding claim, wherein the laser is a continuous laser.

5. The device of any preceding claim, wherein the laser is a pulsed laser.

6. The device of any preceding claim, wherein the pulsed laser is a femtosecond pulsed laser.

7. The device of any one of claims 5 or 6, wherein the pulsed laser is operable at a pulse rate of at least 500 kHz.

8. The device of any preceding claim, further comprising:
a galvanometric mirror (galvo) for controlling the laser to cause that a constant number of laser pulses from the laser lands at least some rows of the spatial light modulator.

9. The device of claim 8, wherein the galvo is located on an optical path between the laser and the spatial light modulator.

10. The device of claim 8, wherein the galvo is configured to control the laser to cause one pulse to land on each row of the spatial light modulator.

11. The device of any one of claims 8-10, wherein the galvo is configured to scan the laser in one dimension, and holographically refocus the laser in a second dimension, using the spatial light modulator.

12. A method, comprising:
directing a beam of light from a laser light into an optical system;
focusing the beam of light from the optical system onto a line on a spatial light modulator;
scanning the beam of light across at least a portion of the spatial light modulator; and
directing the beam of light from the spatial light modulator onto a sample.

13. The method of claim 12, wherein the focused beam of light is focused into a one-pixel width on the spatial light modulator.

14. The method of any one of claims 12 or 13, wherein a galvanometric mirror (galvo) is used for the scanning of the beam of light onto the line on the spatial light modulator.

15. The method of any one of claims 12-14, wherein the beam of light is directed such that positions along a scan direction (y) of the spatial light modulator map to y-positions on the sample, and angular deflections along an orthogonal direction (x) of the spatial light modulator map to x-positions on the sample.

16. The method of any one of claims 12-15, wherein the beam of light is a continuous beam.

17. The method of any one of claims 12-16, wherein the beam of light is a pulsed beam.

18. The method of claim 17, wherein a galvanometric mirror (galvo) is used for scanning the beam of light onto the line on the spatial light modulator, and wherein the timing of laser pulses from the pulsed beam is synchronized with the galvo scanning of the beam of light.

19. The method of claim 18, further comprising:
synchronizing pulses of the pulsed beam with the galvo scan across the spatial light modulator.

20. The method of claim 19, wherein the pulses of the pulsed beam are synchronized with the galvo scan across the spatial light modulator such that a fixed number of pulses lands on each line of the spatial light modulator.

21. The method of any one of claims 17-20, wherein the pulsed beam has a frequency of at least 500 kHz.

22. A method, comprising:
scanning an area in a microscope with millisecond revisit time, with at least 500 individually targeted points of light.

23. The method of claim 22, wherein the light is emitted from a device comprising a spatial light modulator, and a laser in optical communication with the spatial light modulator.

24. The method of claim 23, wherein the spatial light modulator comprises a liquid crystal on silicon chip.

25. The method of claim 23, wherein the spatial light modular comprises a digital micromirror device.

26. The method of any one of claims 23-25, wherein the laser is a pulsed laser.

27. The method of claim 26, wherein the pulsed laser is a femtosecond pulsed laser.

28. The method of any one of claims 26 or 27, wherein the pulsed laser operates at a pulse rate of at least 500 kHz.

29. The method of any one of claims 22-28, wherein the light is directed through an objective of the microscope.

30. The method of any one of claims 23-29, wherein the light achieves multiphoton excitation of a predefined set of the individually targeted points in a plane.

31. A method, comprising:
generating a low voltage differential signal (LVDS) clock signal from a laser oscillator signal of a laser;
converting the low voltage differential signal (LVDS) clock signal to a timebase clock signal;
down sampling the timebase clock signal to create a sample clock signal;
down sampling the laser oscillator signal to produce a pulse picker clock signal; and
adjusting the phase of the sample clock signal with the pulse picker signal, to produce a phase-shifted clock signal; and
with the phase-shifted clock signal, synchronizing timing of pulses of light from the laser with galvo scanning of the light from the laser across the face of a spatial light modulator.

32. The method of claim 31, wherein the timebase clock signal has a 50 percent duty cycle.

33. The method of any one of claims 31 or 32, wherein the laser oscillator signal is a 40 MHz signal.

34. The method of any one of claims 31-33, wherein the LVDS clock signal is generated by a high-speed comparator.

35. The method of any one of claims 31-33, wherein the low voltage differential signal (LVDS) clock is a 40 MHz signal.

36. The method of any one of claims 31-35, further comprising:
routing the laser oscillator signal to a field programmable gate array (FPGA), wherein the FPGA is programmed to convert the low voltage differential signal (LVDS) clock signal to the timebase clock signal.

37. The method of any one of claims 31-36, wherein the timebase clock signal is a 20 MHz timebase clock signal.

38. The method of any one of claims 31-37, wherein the laser internally down samples the laser oscillator signal to produce the pulse picker clock signal.

39. The method of any one of claims 31-38, further comprising:
setting output of the laser with the pulse picker signal; and
triggering data acquisition from a photomultiplier tube (PMT) using the phase-shifted clock signal;
wherein the data acquisition is synchronized to the output of the laser.

40. A method of claim 39, wherein the output of the laser is synchronized with the galvo scanning of the output of the laser across one or more rows of the spatial light modulator.

41. A method of claim 39, wherein the output of the laser is synchronized with the galvo scanning of the output of the laser across all rows of the spatial light modulator.

42. A method, comprising:
configuring a spatial light modulator to direct either even or odd rows of a pulsed laser beam;
measuring diffraction efficiency of the spatial light modulator and galvo feedback voltage for at the time of laser shot for a plurality of galvo cycles;
constructing a map of diffraction efficiency as a function of galvo feedback voltage; and
identifying the galvo feedback voltage that optimizes the diffraction efficiency for each row of the spatial light modulator.

43. The method of claim 42, further comprising:
defining a galvo waveform to align successive laser shots based on the optimized galvo feedback voltage

44. The method of any one of claim 42 or 43, further comprising:
adjusting phase of the galvo control waveform.

45. A method, comprising:
placing a pick off mirror in an optical path of a laser scanning system to reflect a fraction of light from a laser onto a photodiode, the photodiode outputting a corresponding signal;
providing a reference of power for the laser, based on the photodiode signal; and
normalizing recorded fluorescence of the light for the scanning system, based on the reference of power.

46. The method of claim 45, wherein the pick off mirror is placed in front of a tube lens in the optical path.

47. A method, comprising:
creating a wavelength-dependent regional lookup table to linearize phase response across the face of a spatial light modulator in a laser scanning system; and
compensating for phase errors for a mapping of applied voltage to optical phase shift for the spatial light modulator in the laser scanning system, using the lookup table.
